(19) United States
(12) Patent Application Publication
(10) Pub. No.: US 2003/0225691 A1
(43) Pub. Date: Dec. 4, 2003

(54) Method and device for processing an electronic transaction

(75) Inventors: Herve Ruellan, Rennes (FR); Jean-Jacques Moreau, Rennes (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/421,795

(22) Filed: Apr. 24, 2003

(30) Foreign Application Priority Data
Apr. 24, 2002 (FR) 0205130

(51) Int. Cl. G06F 17/60

(52) U.S. Cl. 705/40; 705/39

(57) ABSTRACT

This method of processing an electronic transaction between a client device and a server device in a communication network, comprises the following steps:

receiving a request (RTA) for transaction authorization from the client device (C), the authorization request (RTA) comprising a first payment sum (PS);

detecting a failure of the transaction between the server device (S) and the client device (C); and

sending a message (TC) for canceling the transaction to the client device (C) when the failure is detected, the message (TC) for canceling the transaction comprising a sum for reimbursement by the intermediary device (P) in favor of the client device(C).

The present invention relates to a method and a device for processing an electronic transaction between a client device and a server device.

More particularly, the invention relates to a method of processing an electronic transaction between a client device and a server device, in which method a third party device is used which serves as intermediary for payment of said transaction.

For example, an intermediary payment device may be used to centralize the processing of the electronic payments implemented during electronic transactions between devices within a distributed computer network.

According to this architecture, the client device makes a payment to the intermediary device, this intermediary device making a payment to a server device at the end of the transaction.

This architecture is particularly advantageous for a server device making few transactions, since it does not directly bear the cost of the processing of the payment by the client device.

A method for carrying out payments using a payment intermediary is know from the document U.S. Pat. No. 6,311,170.

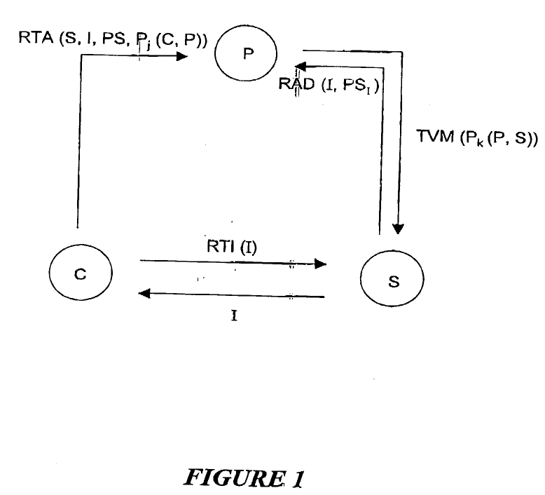

A payment system in accordance with the state of the art and comprising a payment intermediary will now be described with reference to FIG. 1.

More particularly, FIG. 1 represents a client device C, a server device S and an intermediary device P, and the exchange of messages between these different devices during an electronic transaction between the client C and the server S.

In the example described in FIG. 1, it is assumed that the client device C wishes to obtain an image I from the server S, but the mechanism implemented would be equivalent for another type of transaction.

The image I is charged for, but, as described previously, the payment is not carried out directly by the client C in favor of the server S.

On the contrary, the intermediary device P serves as intermediary for payment between the client C and the server S.

Prior to any purchase from the server device P, the client device C transmits a request RTA for transaction authorization to the intermediary device P, this request comprising:

the address S of the server device S;

the identifier I of the image I to be obtained;

a payment sum PS; and

an electronic coin Pⱼ(C, P) belonging to the set of electronic coins usable by the client C to make a payment to the intermediary device P.

By this request RTA for transaction authorization, the client device C notifies the intermediary device P:

that it must reply positively to a request from the server device S for the authorization for the delivery of the image I to the client device C; and

that it accepts to pay the payment sum PS to obtain that image I.

After sending the request RTA for transaction authorization, the client device C sends the server device S a request RTI for transaction initiation, this request comprising the identifier I of the image I to be obtained.

On receiving the request RTI for transaction initiation, the server device S sends the intermediary device a request RAD for authorization to deliver the image I to the client device C.

This request RAD for authorization to deliver comprises:

the identifier I of the image I requested by the client device C; and

the payment sum PS_{I} requested by the server device S to supply the image I to the client device C.

On reception of this request RAD for authorization to deliver, the intermediary device P verifies whether it has received a request RTA for transaction authorization from the client device C to obtain the image I.

If so, the intermediary device P sends a transaction validity message TVM to the server device S, this transaction validity message TVM comprising a coin Pₖ(P, S) belonging to the set of electronic coins usable by the intermediary device P to pay the server device S to settle the sum PS_{I}.

On reception of the transaction validity message TVM, the server S verifies the validity of the payment received from the intermediary device P at the preceding step, and transmits the image I to the client device C when this payment is validated.

The mechanism described in FIG. 1 nevertheless poses a problem when the transaction is not carried out after the payment by the client device C to the intermediary device P. This may be the case if the server device S has broken down or, more generally, is not available, or if the user of the client device C decides not to go through with the transaction, for example.

The present invention enables this problem to be solved by enabling the transaction to be cancelled by the intermediary device S.

The present invention relates more particularly to a method of processing an electronic transaction between a client device and a server device in a communication network. This method is implemented within an intermediary device of the communication network and it comprises the following steps:

receiving a request for transaction authorization from the client device, this authorization request comprising a first payment sum;

detecting a failure of the transaction between the server device and the client device; and

sending a message for canceling the transaction to the client device when the failure is detected, this message for canceling the transaction comprising a sum for reimbursement by the intermediary device in favor of the client device.

Thus, if the intermediary device detects that the transaction is not being correctly made, it sends a message of cancellation of the transaction to the client device. This may in particular occur when the server device is not available, or if the network is overloaded.

This canceling message is accompanied by a reimbursement by the intermediary device in favor of the client device.

In a preferred embodiment, the reimbursement sum is at most equal to the payment sum paid by the client device in favor of the intermediary device.

According to a first feature, the detection step comprises a step of receiving a request for cancellation from the client device (C).

According to this first feature, the user of the client device may deliberately cancel the transaction, by sending a cancellation request to the intermediary device which, on reception of this request, notes the cancellation of the transaction.

Preferentially, the failure of the transaction is detected when a period at least equal to a predetermined period has passed between the reception of the request for transaction authorization and the reception of the cancellation request.

In a particular embodiment, the detection step comprises an attempt to set up a communication with the server device.

Thus, if the server device is not reachable, for example, when the server device is down, or when the communication network is overloaded, the intermediary device detects the failure of the transaction and reimburses the client device.

According to a preferred feature of this embodiment, the failure of the transaction is detected when the attempt to set up communication fails for a period at least equal to a predetermined period.

This feature makes it possible to avoid the cancellation of the transaction in case of a temporary difficulty to reach the server device, for example in case of transient congestion of the communication network.

According to another preferred embodiment, the method further comprises, prior to the detection step, a step of receiving, from the server device, a request for authorization to deliver comprising a second payment sum.

In this preferred embodiment, the failure of the transaction is detected if the second payment sum is greater than the first payment sum.

Thus, the intermediary device checks that the sum received by the server device for making the transaction, is less than the first payment sum paid by the client device in favor of the intermediary device.

In a complementary manner, the invention relates to a device for processing an electronic transaction between a client device and a server device in a communication network. This processing device may be incorporated in an intermediary device of the communication network and comprises:

means for receiving a request for transaction authorization from the client device, the authorization request comprising a first payment sum;

means for detecting a failure of this transaction between the server device and the client device;

means for sending a message of cancellation of that transaction to the client device when the failure is detected, this message of cancellation of the transaction comprising a sum for reimbursement by the intermediary device in favor of the client device.

The invention also relates to an intermediary device comprising means adapted to implement a processing method as briefly described above.

The invention also relates to an intermediary device comprising a processing device as described briefly above.

The invention also relates to an electronic transaction system in a communications network comprising an intermediary device as briefly described above.

The invention also relates to an information carrier readable by a computer system, possibly wholly or partly removable, in particular a CD-ROM or magnetic medium, such as a hard disk or a diskette, or a transmissible medium, such as an electrical or optical signal, and comprising instructions of a computer program enabling the implementation of a processing method as briefly described above, when this program is loaded and run by a computer system.

The invention also relates to a computer program stored on an information carrier, said program comprising instructions enabling the implementation of a processing method as briefly described above when this program is loaded and executed by a computer system.

Since the particular advantages and features of the processing devices, intermediary devices, electronic transaction system, information carrier and of the computer program are the same as those set out above concerning the processing method according to the invention, they will not be repeated here.

Other features and advantages of the present invention will appear more clearly on reading the description of the specific embodiments which follow, this description being given solely by way of non-limiting example and made with reference to the accompanying drawings in which:

FIG. 1, already described, represents a payment system comprising a payment intermediary in accordance with the state of the art;

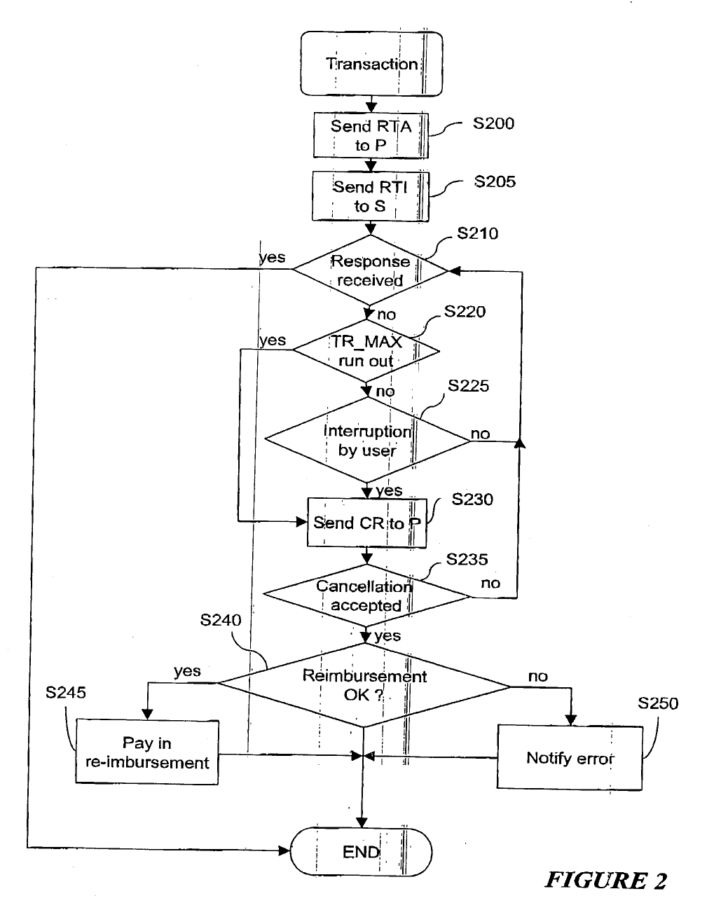

FIG. 2 represents, in the form of a flowchart, the main steps implemented by a client device during a transaction, in accordance with the present invention;

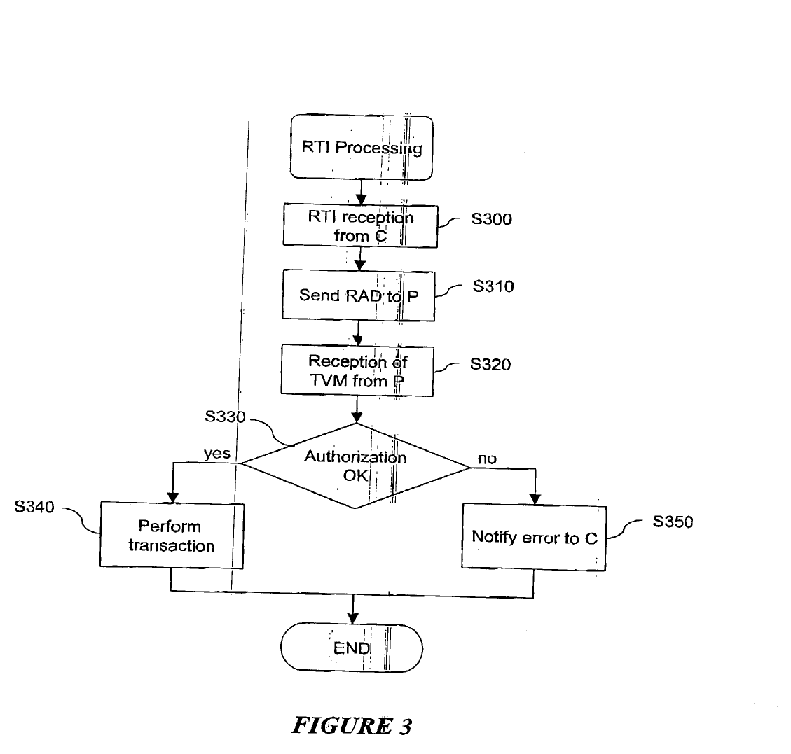

FIG. 3 represents, in the form of a flowchart, the processing of a request for transaction initiation by a server device in accordance with the present invention;

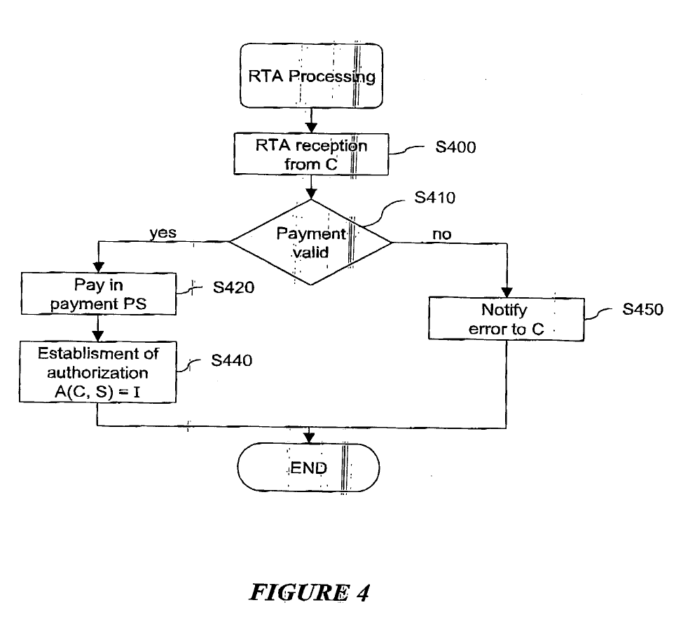

FIG. 4 represents, in the form of a flowchart, the processing of a request for transaction authorization by an intermediary device in accordance with the present invention;

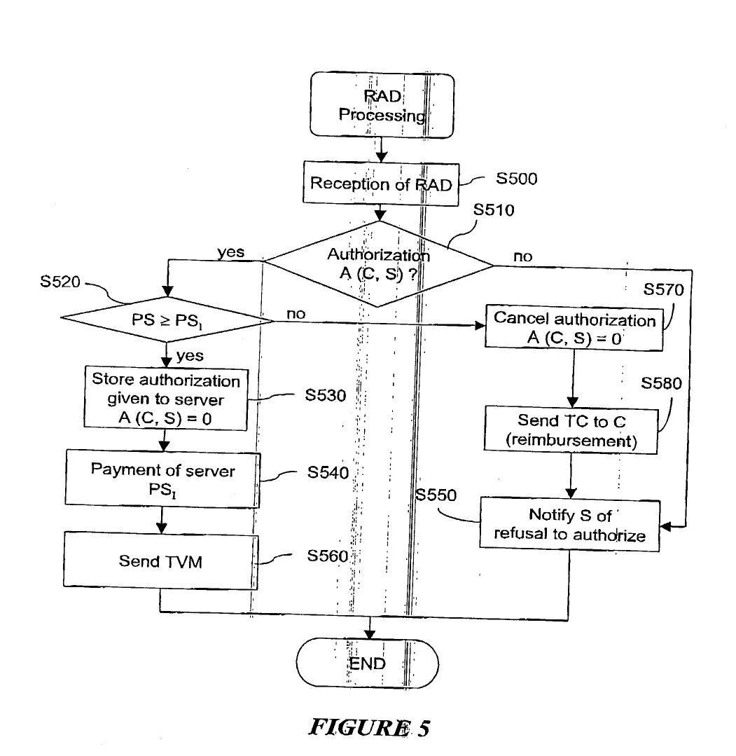

FIG. 5 represents, in the form of a flowchart, the processing of a request RAD for authorization to deliver by an intermediary device in accordance with the present invention;

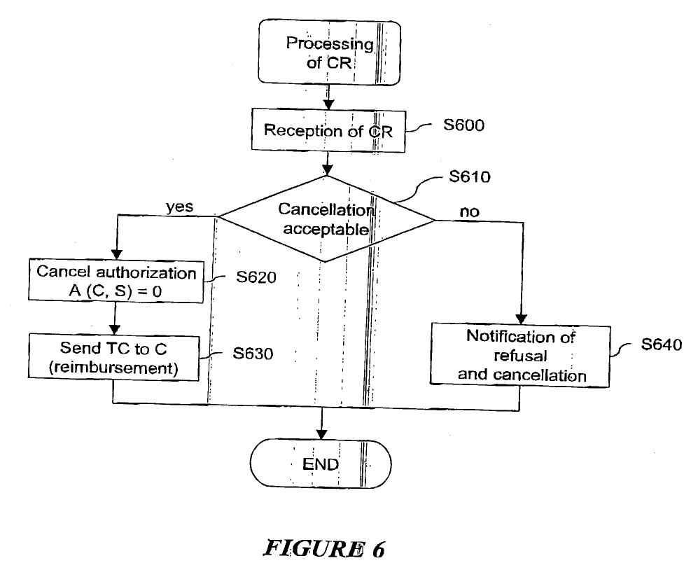

FIG. 6 represents, in the form of a flowchart, the main steps of processing a cancellation request, in accordance with the present invention;

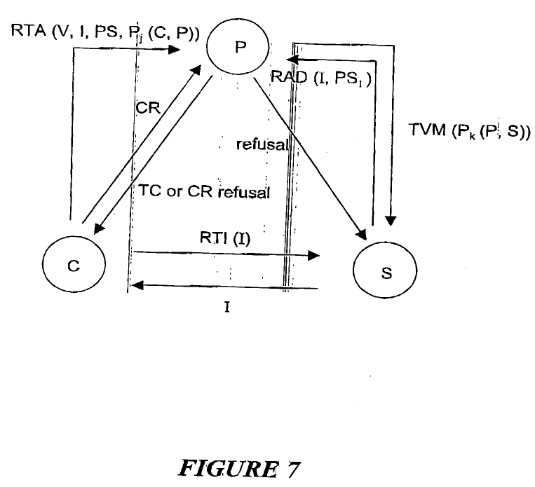

FIG. 7 is an overall representation of the exchange of messages and requests between an intermediary payment device and a server device during an electronic transaction, in accordance with the present invention; and

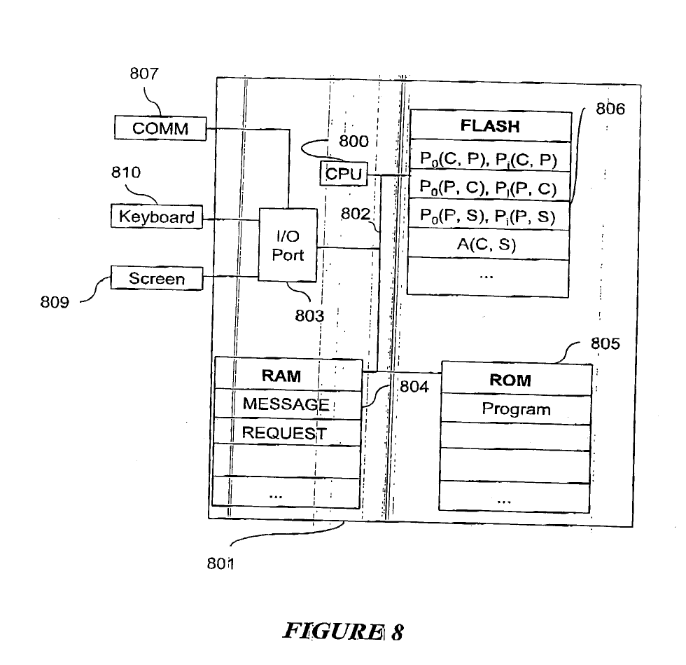

FIG. 8 is a diagram of an intermediary payment device adapted to implement a processing method according to the present invention, in a preferred embodiment.

FIG. 2 represents the main steps S200 to S250 implemented by a client device C during a transaction in accordance with the present invention.

In the preferred embodiment described here, the payments are made by means of the PayWord system that Rivest and Shamir have proposed.

A description of this system can be consulted at the Internet address http:/theory.Ics.mit.edu/˜rivest/RivestShamir-mpay.ps.

Generally, this system consists in recursively generating, from a random number Pₙ and a hash function h, a series of electronic coins Pₙ, Pₙ₋₁, . . . , P₀ by the formula Pₙ₋₁=h(Pₙ).

This hash function has the particularity of not being reversible, such that it is impossible in practice to find the previous number Pₙ from a number Pₙ₋₁.

The end P₀ of the chain thus obtained is known as the root coin and makes it possible to verify the authenticity of the other coins.

In the description that follows the notation P(M, N) will be adopted to designate the series of coins used by a device M to make a payment to a device N.

For example, according to this notation, the series of electronic coins P(C, P) is a series of coins used by the client device C to make a payment to an intermediary device P.

During the first step S200 the client device C sends a request RTA for transaction authorization to the intermediary device P.

As already described, this request RTA for transaction authorization comprises:

the address S of the server device S;

the identifier I of the image I to be obtained;

a payment sum PS; and

an electronic coin Pⱼ (C, P) belonging to the set of electronic coins P(C, P) usable by the client to make a payment to the intermediary device P.

In the embodiment based on the payment system PayWord, this electronic coin Pⱼ(C, P) is such that all the coins of index strictly less than j of the set of coins P(C, P) have already been validated for earlier payments by the intermediary device P.

Step S200 is followed by a step S205 during which the client device C sends a request RTI for transaction initiation to the server device S.

This request RTI for transaction initiation comprises the identifier I of the image to be obtained.

Step S205 is followed by a test S210 during which the client device C verifies if it has received the image I from the server device S in reply to the request RTI for transaction initiation sent at step S205.

If this is the case, the result of the test S210 is positive. This test then terminates the procedure implemented by the client device C to perform a transaction with the server device S according to the invention.

On the other hand, if the client device C has not received the image I from the server device S the result of test S210 is negative.

This test is then followed by a test S220 during which the client device C verifies whether, since the transmission of the request RTI for transaction initiation, the period TR_MAX has run out.

This constant TR_MAX is stored in a register of a non-volatile ROM memory of the client device C.

If this is the case, the result of the test S220 is positive. This test is then followed by a step S230 during which the client device C sends a cancellation request CR to the intermediary device P.

The processing of the cancellation request CR by the intermediary device P will be described later with reference to FIG. 6.

Whatever the case, following the transmission of the cancellation request CR to the intermediary device P, the client device awaits a response to the cancellation request CR sent to the intermediary device P at step S230. This response may be:

either a reimbursement (cancellation accepted);

or a notification of rejection of the cancellation request CR.

Step S230 is followed by a test S235 during which the client device C verifies whether the cancellation request CR has been accepted by the intermediary device P.

If this is not the case, the result of the test S235 is negative. This test is then followed by the test S210 already described.

Returning to test S220, it the period TR_MAX has not run out since the sending of the request RTI for transaction initiation, the result of this test is negative.

This test is then followed by a test S225 during which the client device C verifies whether the user of the client device C has explicitly requested an interruption of the transaction.

If this is the case, the result of the test S225 is positive. This test is then followed by step S230 of sending the cancellation request CR to the intermediary device P already described.

On the other hand, if the user of the client device C has not explicitly interrupted the transaction, the result of test S225 is negative. This test is then followed by the test S210 already described.

Steps S210, S220, S225, S230, and S235 thus constitute a loop whose execution terminates:

either when the result of test S210 is positive, which occurs when the client device C has received the image I in response to the request RTI for transaction initiation sent at step S205;

or because the maximum period TR_MAX has gun out since the sending of the request RTI for transaction initiation;

or by deliberate interruption of the transaction by the user.

In these last two cases, and as already described with reference to step S230, a cancellation request CR is sent to the intermediary device P.

When the intermediary device P sends a response to the cancellation request CR representing the acceptance of that cancellation, the result of test S235 is positive.

This test is then followed by a test S240 during which the client device C verifies whether the reimbursement received from the intermediary device P is valid.

In the preferred embodiment described here, this reimbursement is carried out by means of electronic coins P(P, C) in accordance with the payment system PayWord.

If the reimbursement is valid, the result of the test S240 is positive. This test is then followed by a step S245 during which the client device C pays the reimbursement into its account.

On the other hand, if the reimbursement is not valid, the result of test S240 is negative. This test is then followed by a step S250 of notifying an error to the user of client device C.

Whatever the case, steps S245 and S250 terminate the transaction procedure in accordance with the present invention.

FIG. 3 represents the main steps S300 to S350 of processing a request RTI for transaction initiation by a server device S, in accordance with the present invention;

During the first step S300, the server device S receives a request RTI for transaction initiation from the client device C to obtain an image I.

On reception of that request RTI for transaction initiation, the server device S sends, during a step S310, a request RAD for authorization to deliver to the intermediary device P.

As already described, this request RAD for authorization to deliver comprises the identifier I of the image I requested and the payment sum PS_{I} requested by the server device S to supply the image I to the client device C.

That step S310 is followed by a step S320 during which the server device S receives a transaction validation message TVM, this message comprising an item of information according to which authorization to deliver the image I is granted or not by the intermediary device P.

The sending of this transaction validation message TVM will be described later with reference to FIG. 5.

Step S320 is followed by a test S330 during which the server device S verifies whether that authorization has been granted.

If this is the case, the result of the test S330 is positive. This test is then followed by a step S340 during which the server device S transmits the image I to the client device C.

On the other hand, if the authorization is not granted by the intermediary device P, the result of the test S330 is negative.

This test is then followed by a step S350 of notifying a transaction error to the client device C.

Steps S340 and S340 terminate the procedure of processing a request RTI for transaction initiation according to the present invention.

FIG. 4 represents the main steps S400 to S450 of procedure for processing a request RTA for transaction authorization by an intermediary device P in accordance with the present invention;

During the first step S400, the intermediary device P receives the request RTA for transaction authorization from the client device C.

The sending of this request RTA for transaction authorization has already been described with reference to step S200 of FIG. 2.

This step S400 of receiving a request RTA for transaction authorization is followed by a step S410 during which the intermediary device P verifies the validity of the payment associated with the request RTA for transaction authorization.

This verification is performed, in the preferred embodiment described here, by verifying whether the electronic coin Pⱼ(C, P) contained in the request RTA for transaction authorization enables a payment of sum PS to be made, this sum being also included in the request RTA for transaction authorization.

If the payment is valid, the result of the test S410 is positive. This test is then followed by a step S420 during which the intermediary device P pays into its own account the payment sum PS contained in the request RTA for transaction authorization.

Step S420 is followed by a step S440 during which the intermediary device P stores an item of information A(C, S) according to which the client device C authorizes the intermediary device P to reply positively to a request RAD for authorization to deliver from the server device S to deliver the image I and for a payment sum PS.

In the embodiment described here, the item of information A(C, S) explicitly comprises the payment sum PS and the identifier I of the image I to obtain.

On the other hand, if the payment associated with the request RTA for transaction authorization is not validated, the result of test S410 is negative. This test is then followed by a step S450 during which the intermediary device P notifies the client device P of an error.

Whatever the case, the steps S440 and S450 terminate the procedure of processing a request RTA for transaction authorization according to the present invention.

FIG. 5 represents the main steps S500 to S580 of a procedure for processing, by the intermediary device P, of a request RAD for authorization to deliver from the server device S.

During a first step S500, the intermediary device P receives a request RAD for authorization to deliver sent by the server device S at step S310 as described earlier with reference to FIG. 3.

Step S500 of receiving a request RAD for authorization to deliver is followed by a step S510 during which the intermediary device P verifies whether it has received an authorization from the client device C for the delivery of an image I to the server device S, by comparing the identifier I read in the request RAD for authorization to deliver with the image identifier stored in the item of information A(C, S) during step S440 already described.

In practice, this test consists of reading whether the register of the non-volatile memory A(C, S) has been updated in accordance with step S440 described earlier.

If such an authorization has not been given, the result of test S510 is negative. This test is then followed by a step S550 during which the intermediary device P notifies the server device S that the client has not authorized the intermediary device P to accept that transaction.

On the other hand, if such an authorization has been given, the result of test S510 is positive.

This test is then followed by a test S520 during which the intermediary device P verifies whether the payment sum PS stored in the item of information A(C, S) at step S440 on reception of the request RTA for transaction authorization is greater than or equal to the payment sum PS_{I} included in the request RAD for authorization to deliver received at step S500.

If this is not the case, it means that the server device S demands a sum PS_{I} greater than the sum PS paid by the client device C in favor of the intermediary device P. In this case, the result of the test S520 is negative.

This test is then followed by a step S570 during which the intermediary device P cancels the authorization received from the client device C at step S400.

In practice, this amounts to storing the value 0 in the register A(C, S).

Step S570 of canceling the authorization is followed by a step S580 during which the intermediary device P reimburses the client device C by means of electronic coins P(P, C).

In practice, this reimbursement is carried out by the sending of a message TC of transaction cancellation to the client device C.

In the preferred embodiment described here, the reimbursement sum is less than the payment sum PS received in the request RTA for transaction authorization received at step S400 already described.

Step S580 is followed by the previously described notification step S550.

On the other hand, if the sum PS_{I} demanded by the server device S is less than or equal to the sum PS that the client has paid for the transaction, the result of test S520 is positive.

This test is then followed by a step S530 during which the intermediary device P stores in memory the fact that the authorization for the transaction has been given to the server device S.

In practice, this amounts to storing the value 0 in the register A(C, S).

This memorization step S530 is followed by a step S540 of the payment by the intermediary device P of the sum PS_{I} to the server device S, by means of electronic coins P(P, S).

Step S540 of payment of the server device S is followed by a step S560 during which the intermediary device P sends the server device S a transaction validation message TVM, this message TVM comprising an item of information representing the acceptance of the transaction.

The steps S550 of notifying the server S, and S560 of sending the server S the transaction validation message TVM terminate the procedure of processing a request RAD for authorization to deliver according to the invention.

FIG. 6 represents the main steps S600 to S640 of processing a request CR for cancellation by the intermediary device P.

During the first step S600, the intermediary device P receives the cancellation requests CR sent by the client device at step S230 already described.

This cancellation request CR is sent either when the period TR_MAX has run since the sending of the request RTI for transaction initiation, this request having remained without any response (result of test S220 positive), or deliberate interruption by the user (result of test S225 positive).

Step S600 is followed by a test S610 during which the intermediary device verifies whether that cancellation is acceptable.

In a first variant embodiment, a cancellation request is acceptable if a predetermined period has passed since the reception of the request RTA for transaction authorization, in accordance with step S400 just described.

In a second variant embodiment, that cancellation request CR is acceptable if the server device S cannot be reached, in the case of a breakdown or a network problem for example.

In this variant embodiment, during the test S610 of verifying the acceptability of the cancellation, the intermediary device P carries out an attempt at connection with the server device S to verify whether it actually is unreachable.

Whatever the case, when the intermediary device P considers that the cancellation request CR is acceptable, the result of the test S610 is positive.

In that case, test S610 is followed by a step S620 during which the intermediary device P cancels the authorization received from the client device C at step S400, then by a step S630 for reimbursing the client device C.

In the preferred embodiment described here, steps S620 and S630 are similar to steps E570 and E580 already described with reference to FIG. 5.

Authorization cancellation step S620 is followed by a step S630 during which the intermediary P reimburses the client device C by means of electronic coins P(P, C) for a sum less than or equal to the payment sum PS received in the request RTA for transaction authorization at step S400 already described.

In a preferred embodiment, the reimbursement sum is strictly less than the payment sum PS received in the authorization request RTA, the difference between these sums being used to remunerate the intermediary device P.

On the other hand, if the intermediary device P considers that the cancellation request CR received at step 5600 is not acceptable, the result of test S610 is negative. This test is then followed by a step S640 of notifying the client device C of the rejection of the cancellation request CR.

Whatever the case, the steps S630 of reimbursement and S640 of rejection notification terminate the procedure of processing a cancellation request CR according to the present invention.

FIG. 7 is an overall representation of the exchange of messages and requests between a client device C, server device S, and an intermediary device P during an electronic transaction between the client C and the server S, in accordance with the present invention.

FIG. 8 is a diagram of an intermediary payment device adapted to implement a processing method according to the present invention, in a preferred embodiment.

This intermediary device may in particular be constituted by a computer.

In the example embodiment described here, the intermediary payment device comprises a communication card 807 to connect the intermediary device to a communication network, a keyboard 810, and a screen 809, connected to an input/output port 803 of a processing card 801.

The processing card 801 comprises, connected together by an address and data bus 802:

a central processing unit 800;

a random access memory RAM 804;

a read only memory ROM 805;

a non-volatile memory FLASH 806 and

the input/output port 803.

Each of the elements illustrated in FIG. 8 is well known to a person skilled in the art of microcomputers and, more generally, of information processing systems. These common elements are therefore not described here.

The random access memory 804 comprises in particular:

A register REQUEST for storing any type of request received from the client device or from the server device, that is to say in particular, a request RTA for transaction authorization, a request RAD for authorization to deliver, and a cancellation request CR.

a register MESSAGE to store, prior to them being sent, the messages destined for the client device and for the server device and in particular the messages of transaction validity TVM and of transaction cancellation TC.

The non-volatile memory FLASH 806 comprises registers to store, in accordance with the payment system PayWord, the root coin P₀ and the last coin Pⱼ validly received for the series of coins P(C, P), P(P, C) and P(P, S), respectively used for:

the payments made by the client device C in favor of the intermediary device P;

the reimbursements made by the intermediary device P in favor of the client device C in case of cancellation of the transaction, and

the payments made by the intermediary device P in favor of the server device S in case of cancellation of the transaction.

The non-volatile memory FLASH 806 also comprises a register A(C, S) for storing the information A(C, S) according to which the client device C authorizes the intermediary device P to reply positively to a request RAD for authorization to deliver coming from the server device S.

The read only memory 805 is adapted to store the operating program of the central processing unit 800. It comprises in particular a register “Program” to store the instructions of a program implementing a processing method according to the invention, as described earlier with reference to the flow diagram of FIGS. 2 to 6.

The processing device comprises conventional communication means known to the person skilled in the art, adapted to communicate, by means of requests and messages with other devices of the communication network.

These communication means are in particular constituted by the communication card 807 and portions of computer code stored in the read-only memory ROM 805 implementing the conventional protocol layers such as TCP/IP.

Whatever the case, these communication means constitute receiving means adapted to receive a request RTA for transaction authorization, a request RAD for authorization to deliver and a cancellation request CR as described earlier, as well as means for sending a transaction cancellation message TC to the client device C when the failure is detected.

The communication means are in particular adapted to recognize the type of a request received and to extract from it the different fields.

The processing device comprises means for detecting a failure of the transaction between the server device S and the client device C. In the preferred embodiment described here, these detection means cooperate with a clock, not shown here, and are adapted to calculate a period that has passed between the reception of a request for transaction authorization and the reception of a cancellation request CR.

These detection means comprise means for setting up a communication with the server device S. In the preferred embodiment, the means for setting up the communication use the services of protocol layers defined above, for example the function PING known to the person skilled in the art.

More particularly, the means for setting up a communication are adapted to attempt to set up a communication with the server for a predetermined period, and to generate a signal if the communication cannot be set up during the said period.

The detection means are also adapted to detect the failure of the transaction if the second payment sum read in the request RAD for authorization to deliver is greater than the first payment sum PS read in the request RTA for transaction authorization.

1. A method of processing an electronic transaction between a client device and a server device in a communication network, said processing method being implemented within an intermediary device of the communication network and comprising the following steps:
receiving, a request for transaction authorization from the client device, said authorization request comprising a first payment sum;
detecting a failure of said transaction between the server device and the client device; and
sending a message for canceling said transaction to the client device when said failure is detected, said message for canceling the transaction comprising a sum for reimbursement by the intermediary device in favor of the client device.

2. A processing method according to claim 1, wherein said detection step comprises a step of receiving a cancellation request from said client device.

3. A processing method according to claim 2, wherein the failure of the transaction is detected when a period at least equal to a predetermined period has passed between the reception of the request for transaction authorization and the reception of said cancellation request.

4. A processing method according to claim 1, wherein said detection step comprises attempt to set up a communication with said server device.

5. A processing method according to claim 4, wherein the failure of the transaction is detected when said attempt to set up communication fails for a period at least equal to a predetermined period.

6. A processing method according to claim 1, further comprising, prior to said detection step, a step of receiving, from the server device, a request for authorization to deliver comprising a second payment sum, and where the failure of the transaction is detected if said second payment sum is greater than said first payment sum.

7. A device for processing an electronic transaction between a client device and a server device in a communication network, said processing device being able to be incorporated in an intermediary device of the communication network and comprising:
means for receiving a request for transaction authorization from the client device, said authorization request comprising a first payment sum;
means for detecting a failure of said transaction between the server device and the client device; and
means for sending a message for canceling said transaction to the client device said failure is detected, said message for canceling the transaction comprising a sum for reimbursement by the intermediary device in favor of the client device.

8. A processing device according to claim 7, wherein said detection means comprise means for receiving a request for cancellation from said client device.

9. A processing device according to claim 8, wherein said detection means are adapted to calculate a period that has passed between the reception of said request for transaction authorization and the reception of said cancellation request, and to detect the failure of the transaction when said period is greater than a predetermined period.

10. A processing device according to claim 7, wherein said detection means comprise means for setting up a communication with said server device.

11. A processing method according to claim 10, wherein that said detection means are adapted to detect the failure of the transaction, when said means for setting up a communication do not manage to set up a communication with the server device for a period at least equal to a predetermined period.

12. A processing device according to claim 7, wherein said receiving means are adapted to receive, from the server device, a request for authorization to deliver comprising a second payment sum, and in that said detection means are adapted to detect the failure of the transaction if said second payment sum is greater than said first payment sum.

13. An intermediary device, comprising means adapted to implement a processing method according to claim 1.

14. An intermediary device comprising a processing device according to claim 7.

15. An electronic transaction system in a communication network comprising an intermediary device according to claim 13.

16. An information carrier readable by a computer system, possibly wholly or partly removable, it particular a CD-ROM or magnetic medium, such as a hard disk or a diskette, or a transmissible medium, such as an electrical or optical signal, characterized in that it comprises instructions of a computer program enabling the implementation of a processing method according to claim 1, when this program is loaded and run by a computer system.

17. A computer program stored on an information carrier, said program comprising instructions enabling the implementation of a processing method according to claim 1, when this program is loaded and executed by a computer system.
